(19) United States
(12) Patent Application Publication
(10) Pub. No.: US 2007/0140336 A1
(43) Pub. Date: Jun. 21, 2007

(54) Video coding device and image recording/reproducing device

(76) Inventors: Isao Karube, Yokohama (JP); Tomokazu Murakami, Kokubunji (JP); Hiroaki Ito, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,444

(22) Filed: Mar. 6, 2006

(30) Foreign Application Priority Data
Nov. 8, 2005 (JP) JP2005-323003

(51) Int. Cl. H04N 7/12; H04N 11/02; H04N 11/04

(52) U.S. Cl. 375/240.08; 375/240.16; 375/240.24

(57) ABSTRACT

A video coding device for encoding video images comprises a block matching processing unit which executes a block matching process for each of a plurality of blocks obtained by partitioning each of the video images and a characteristic detecting unit which detects a characteristic of each block. Pixels corresponding to the characteristic detected by the characteristic detecting unit are selected from each block as pixels to be used for the block matching process, and the block matching process is executed using the selected pixels. The video coding device realizes the reduction of the number of calculations and processing time of the coding process.

### INCORPORATION BY REFERENCE

The present application claims priority from Japanese application JP2005-323003 filed on Nov. 8, 2005, the content of which is hereby incorporated by reference into this application.

### BACKGROUND OF THE INVENTION

1. Field of the Invention

The present invention relates to a technique for encoding digital video images.

2. Description of the Related Art

Video encoding methods executing motion compensation by detecting a motion vector for each macro block (e.g. MPEG-1 and MPEG-2 as international video encoding standards) are well-known today as inter-frame/intra-frame adaptive coding methods. The macro block is the unit of the motion compensation, formed by a luminance signal block including four blocks (having 8×8 pixels) and two color difference signal blocks (having 8×8 pixels) spatially corresponding to the luminance signal block. The motion vector is a vector used in motion compensation prediction for indicating the position of a compared area in a reference image that corresponds to the macro block of a coded image.

In the motion compensation, a method called “block matching”, detecting the motion vector for each macro block and thereby finding a similar block in a reference frame, is used widely. The details of such a coding process including the block matching process for realizing high precision video encoding are disclosed in Gary J. Sullivan and Thomas Wiegand: Rate-Distortion Optimization for Video Compression, IEEE Signal Processing Magazine, vol. 15, no. 6, pp. 74-90, November 1998 (H.264/AVC).

### SUMMARY OF THE INVENTION

However, the coding process according to the method of the above document requires a far larger number of calculations compared to MPEG-1 and MPEG-2. Further, the above method uses all the points (pixels) in each block for the block matching in the motion search, resulting in an extremely heavy coding workload. In cases where input video images are encoded, compressed and stored in a record medium by a video camera or hard disk recorder, for example, such a heavy coding workload causes a very long processing time of the coding process. Therefore, real time recording of video of a large image size or high resolution becomes difficult as the coding workload becomes heavier.

The present invention has been made in consideration of the above problems. It is therefore the primary object of the present invention to provide a technique suitable for reducing the number of calculations for the coding process. The present invention provides a device capable of finely executing real-time video recording by use of such a technique.

To achieve the above object, in the present invention, a characteristic (image characteristic) is detected in each of a plurality of blocks obtained by partitioning each video image, and the block matching process is executed using pixels corresponding to the detected characteristic. In other words, the block matching process in the present invention is executed by preferentially using pixels having the characteristic (characteristic pixels). For example, the block matching process is executed using the pixels having the characteristic (characteristic pixels) only, without using other pixels.

The image characteristic can be an edge in the image, for example. Pixels having an edge intensity greater than or equal to a prescribed value or pixels having a maximum edge intensity may be detected and used as the characteristic pixels. It is possible to further partition each block into a plurality of detecting areas, select a pixel having the maximum characteristic value (e.g. edge intensity) from each of the detecting areas of the block as a representative point of the block, and execute the block matching process using the representative points of the block selected from the detecting areas. When the characteristic values of all the pixels contained in the detecting areas are less than the prescribed value, the block matching process may be executed using prescribed pixels selected and extracted from the block.

By the present invention, the coding workload on the coding process employing the block matching process can be reduced, by which a high speed coding process is realized.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of the composition of a video coding device in accordance with an embodiment of the present invention;

FIG. 2 is a schematic diagram showing an example of a process executed by an image characteristic detecting unit and a motion detection/compensation unit of the video coding device of FIG. 1;

FIG. 3 is a schematic diagram showing examples of a block matching process executed by the video coding device of FIG. 1 and a conventional video coding device.

FIG. 4 is a schematic diagram showing another example of the process executed by the image characteristic detecting unit and the motion detection/compensation unit;

FIG. 5 is a block diagram showing an example of an image recording/reproducing device to which the present invention is applied;

FIG. 6 is a table showing principal conditions of a simulation experiment on the coding process;

FIG. 7 is a table showing the result of the simulation experiment; and

FIG. 8 is a graph showing rate-distortion properties achieved by various comparison methods.

### DESCRIPTION OF THE INVENTION

Referring now to the drawings, a description will be given in detail of a preferred embodiment in accordance with the present invention.

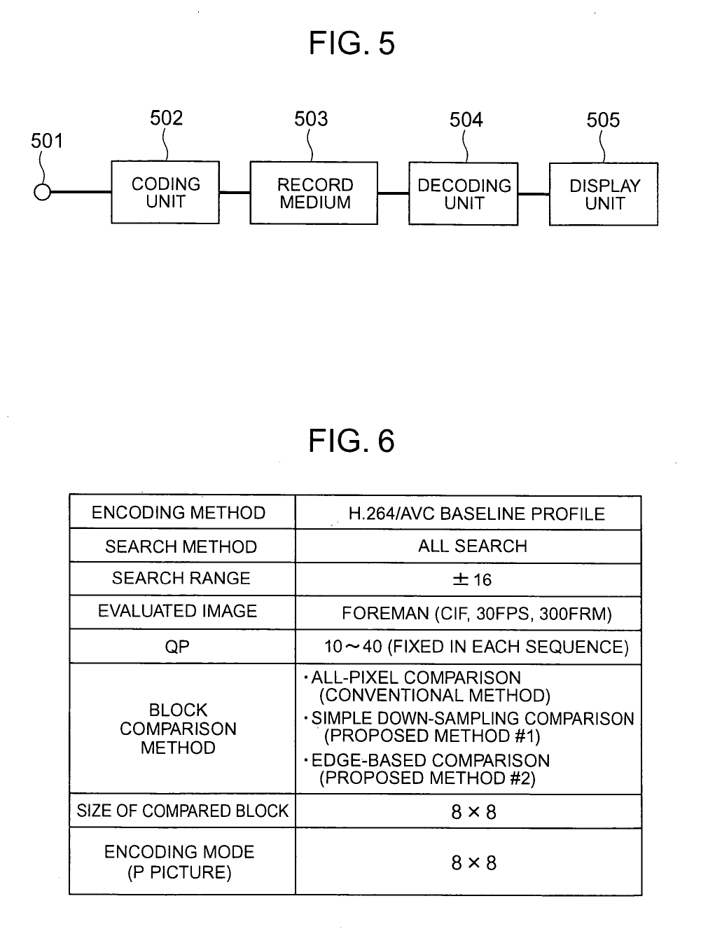

First, an example of an image recording/reproducing device to which the present invention is applied will be described referring to FIG. 5. The image recording/reproducing device shown in FIG. 5 can be, for example, a video camera for shooting video and recording the video (video images) in a record medium like an optical disk, tape, etc. (or a cellular phone having such a video-shooting function), a hard disk recorder or DVD recorder for recording received television programs, a TV set equipped with such a recorder, etc. In other words, the present invention is applicable to video cameras, hard disk recorders, DVD recorders, TV sets, etc. The present invention is of course similarly applicable to any device having functions of encoding and recording video images.

Referring to FIG. 5, video images captured by an image capturing device (e.g. video camera) having image pickup devices (e.g. CCDs) or video images of a received television program, for example, are inputted to a coding unit 502 via an input terminal 501 and encoded in real time by the coding unit 502. The details of the coding process executed by the coding unit 502 will be explained later. The video images encoded by the coding unit 502 are supplied to record medium 503. The record medium 503 record the coded video images. The record medium can be, for example, an optical disk, hard disk, semiconductor memory (e.g. flash memory), tape, etc. The decoding unit 504 decodes and reproduces the coded video images recorded in the record medium and thereby generates a video signal in the RGB format or the component (Y/Cb/Cr) format, for example. The video signal is supplied to a display unit 505 having a display element such as an LCD (Liquid Crystal Display) or PDP (Plasma Display Panel) as needed. The display unit 505 displays the video read out from the record medium 503, according to the video signal supplied from the decoding unit 504.

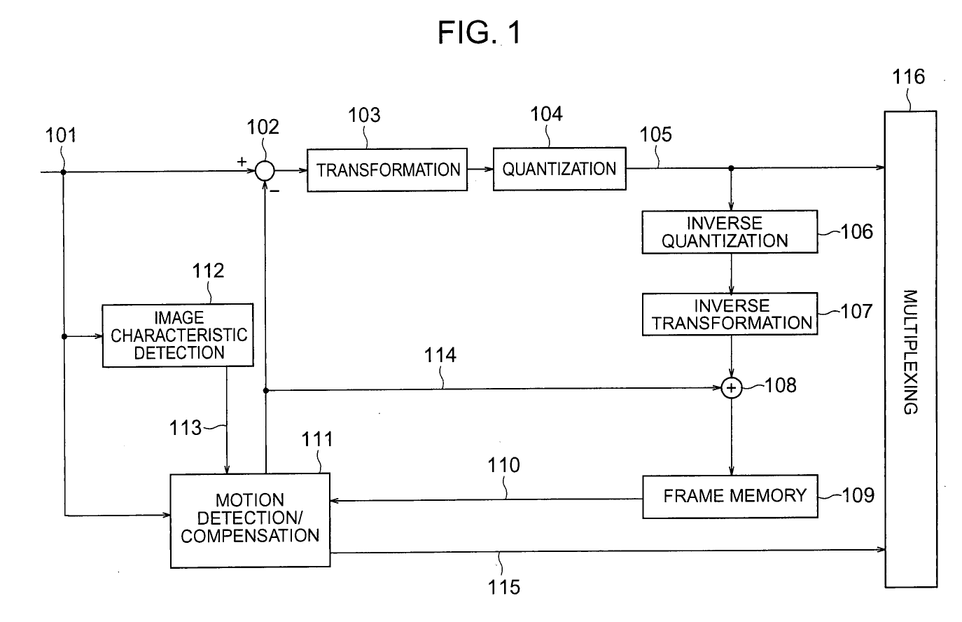

Next, the details of the coding unit 502 will be explained referring to FIG. 1. FIG. 1 is a block diagram showing an example of the composition of the coding unit 502 as a video coding device in accordance with an embodiment of the present invention. The composition shown in FIG. 1 makes it possible to adaptively change the number of error codes. Each input image 101 is supplied to a subtractor 102, an image characteristic detecting unit 112 for detecting a characteristic of the input image, and a motion detection/compensation unit 111 (as a block matching processing unit for detecting motion of the image and compensating for the motion). The subtractor 102 obtains the difference between an image of a block in the input image 101 and a predicted block 114 outputted by the motion detection/compensation unit 111 and outputs the difference as an error signal. The error signal is inputted to a transformation unit 103 which transforms the error signal into DCT (Discrete Cosine Transform) coefficients. The DCT coefficients outputted by the transformation unit 103 are quantized by a quantization unit 104, by which quantized transformation coefficients 105 are generated. The quantization unit 104 also outputs a signal indicating the number of codes of the error signal together with the quantized transformation coefficients 105. The quantized transformation coefficients 105 generated by the quantization unit 104 are supplied to a multiplexing unit 116 as information to be transmitted. The quantized transformation coefficients 105 generated by the quantization unit 104 are also used as information for synthesizing an inter-frame prediction image. Specifically, the quantized transformation coefficients 105 are dequantized by an inverse quantization unit 106, inversely transformed by an inverse transformation unit 107, and is added by an adder 108 to the image predicted block) 114 outputted by the motion detection/compensation unit 111. The output of the adder 108 is stored in a frame memory 109 as a decoded image of the current frame, by which the decoded image of the current frame is delayed for a time period corresponding to one frame and is supplied to the motion detection/compensation unit 111 as a previous frame image 110.

The motion detection/compensation unit 111 executes a motion compensation process by use of the input image 101 (image of the current frame) and the previous frame image 110. The motion compensation process is a process for searching the decoded image of the previous frame (reference image) for a part that is similar to the contents of the target macro block being handled (Generally, in the search area in the previous frame, a part that gives the smallest sum of absolute values of predicted error signals in the luminance signal block is selected.) and obtaining motion information (motion vector) and motion prediction mode information regarding the part (i.e. the aforementioned block matching process). The details of the motion compensation process or block matching process have been described in JP-A-2004-357086, for example.

The motion detection/compensation unit 111 executing the block matching process generates and outputs the predicted macro block image 114 and the motion information & motion prediction mode information 115. The predicted macro block image 114 is outputted to the subtractor 102 as mentioned above, while the motion information & motion prediction mode information 115 is supplied to the multiplexing unit 116. The multiplexing unit 116 multiplexes the quantized transformation coefficients 105 and the motion information & motion prediction mode information 115 together and encodes the multiplexed information.

This embodiment is characterized in that characteristic information on the input image 101 detected by the image characteristic detecting unit 112 is used for the motion compensation process (block matching process) executed by the motion detection/compensation unit 111. The image characteristic detecting unit 112 in this embodiment detects an edge (outline) contained in the image as the characteristic of the image, and outputs data about a pixel having the highest edge intensity (characteristic pixel data 113) to the motion detection/compensation unit 111. In this embodiment, the number of calculations for the motion detection is reduced by using the characteristic pixel data 113 for the block matching process executed by the motion detection/compensation unit 111. The details of the operation will be described below.

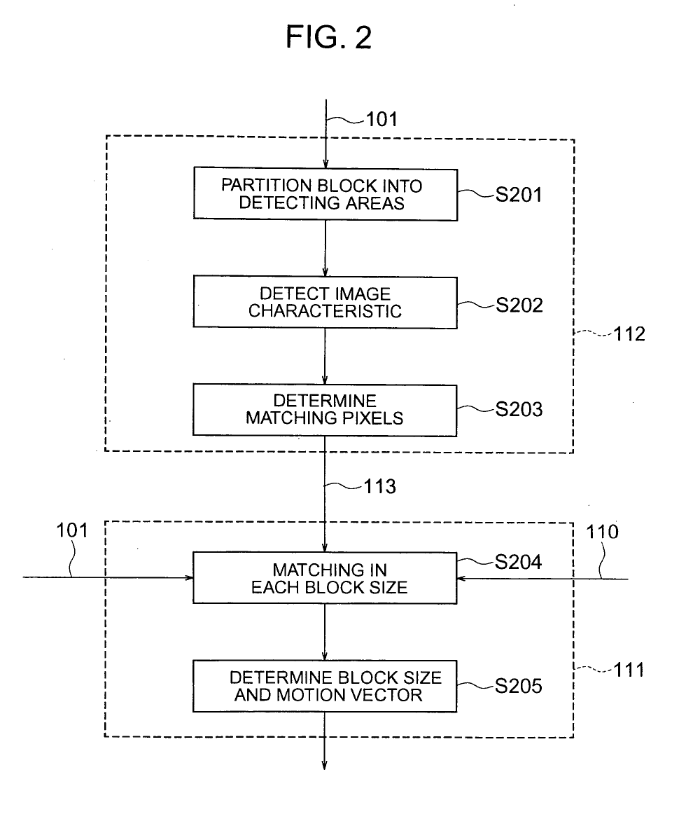

FIG. 2 shows an example of a process executed by the image characteristic detecting unit 112 and the motion detection/compensation unit 111 of the video coding device (coding unit 502) of this embodiment. In this explanation, the input image 101 is assumed to have been partitioned into a plurality of blocks (macro blocks). In step S201, the image characteristic detecting unit 112 further partitions each block of the input image 101 into a plurality of detecting areas for detecting the image characteristic. In the next step S202, the image characteristic detecting unit 112 detects a characteristic value of the image (image characteristic value) in each of the plurality of detecting areas. In this example, the edge intensity in the image is detected as the image characteristic value. The edge (edge intensity) in the image (in each detecting area) is detected by calculating the second order derivative of the pixel signal in the detecting area or by calculating the difference between adjacent pixels in the detecting area, for example. In the next step S203, the image characteristic detecting unit 112 selects and determines a point to be used for the block matching process (characteristic pixel) in each detecting area by use of the information on the image characteristic (image characteristic value) detected in S202. The characteristic pixel is assumed in this example to be a pixel having the highest edge intensity detected in S202 among all the pixels contained in the detecting area, for example. In the next step S204, the motion detection/compensation unit 111 executes the block matching process in each mode (i.e. in each block size) by use of the characteristic pixel data 113 (i.e. data about the point to be used for the block matching process) determined by the image characteristic detecting unit 112 in S203. Therefore, in the block matching process of the step S204, the matching is executed for the characteristic pixels (selected from the detecting areas) only (not executed for other pixels). Incidentally, while the block matching process is assumed to be executed in every mode (every block size) in this example, the execution of the block matching process in every mode is not necessarily required.

While the matching in the block matching process is executed for every pixel in a block in conventional methods, not all the pixels are necessarily needed even when a large number of pixels are used for the matching. Therefore, it is sometimes impossible in conventional methods to achieve marked effect comparable to the heavy workload. In this embodiment, pixels to be used for the block matching process are selected or narrowed down (restricted to the aforementioned “characteristic pixels” only, for example) based on the image characteristic, by which the number of pixels used for the block matching process can be reduced and the workload can be lessened. Consequently, processing speed of the coding process is increased.

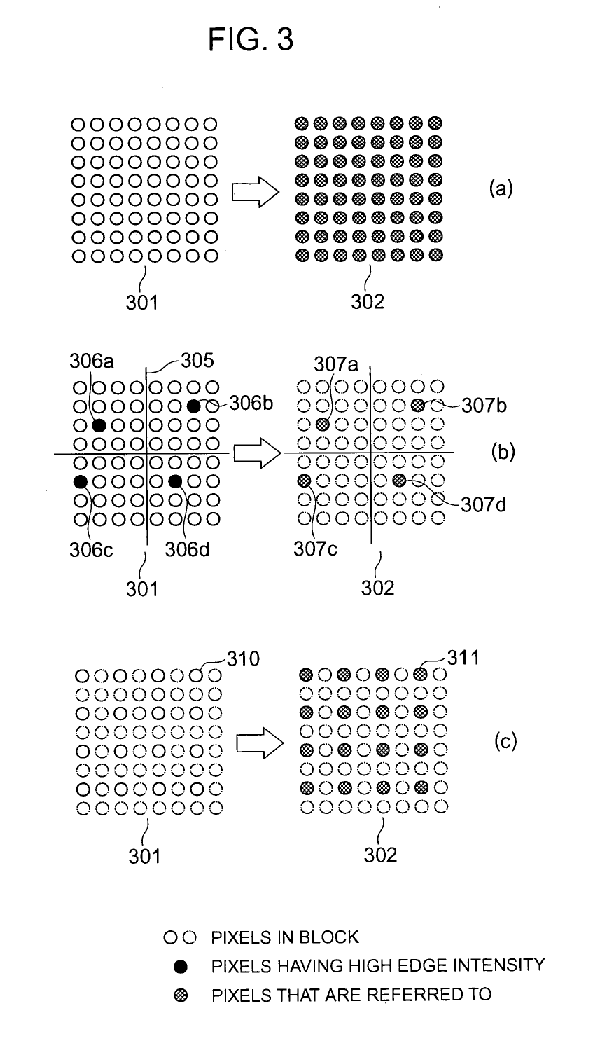

Next, an example of the block matching process according to this embodiment will be described below. FIGS. 3A-3C are schematic diagrams showing examples of the block matching process executed using the input image and the reference image by the video coding device (coding unit 502) of this embodiment and a conventional video coding device. In FIGS. 3A-3C, each block of the input image and the reference image used for the block matching process is assumed to include 8 pixels (in the horizontal direction)×8 pixels (in the vertical direction).

Before explaining the block matching process according to this embodiment, a conventional method for the block matching process will be explained first. FIG. 3A shows an example of pixels that are used for the block matching process in a conventional method, in which the block 301 of the input image and the block 302 of the reference image currently searched are both assumed to include 8×8 pixels as mentioned above. In the conventional method, the matching is executed for all the pixels contained in the block 301 of the input image and the block 302 of the reference image, that is, for all the (8×8=)64 pixels in each block. Therefore, the repetition of the matching inside the motion vector search area results in an extremely heavy workload, needing a long processing time for the coding process.

Meanwhile, the block matching process in this embodiment is executed using pixels corresponding to the image characteristic only, as shown in FIG. 3B. In this embodiment, each block 301 of the input image is partitioned into four detecting areas, for example, as shown on the left-hand side of FIG. 3B. The measurement or detection of the edge intensity is executed for each of the pixels contained in each detecting area. Based on the result of the measurement of edge intensity, a point (pixel) having the highest edge intensity (amplitude of an edge component) is selected and determined in each detecting area as a representative point (306a, 306b, 306c, 306d) of the detecting area. For example, as shown on the left-hand side of FIG. 3B, the pixels 306a, 306b, 306c and 306d are selected as the representative points of the upper left detecting area, upper right detecting area, lower left detecting area and lower right detecting area, respectively. Four points 307a, 307b, 307c and 307d in the block 302 of the reference image are situated at the same intra-block positions as the four representative points 306a, 306b, 306c and 306d in the block 301 of the input image and thus the matching is executed for the four points only, by which the number of pixels used for the matching is reduced considerably.

However, there is a possibility that the edge intensity detected in each detecting area shown in FIG. 3B is very low and satisfactory effect can not be expected from the use of such a value for the search. In such cases, a different process should be considered.

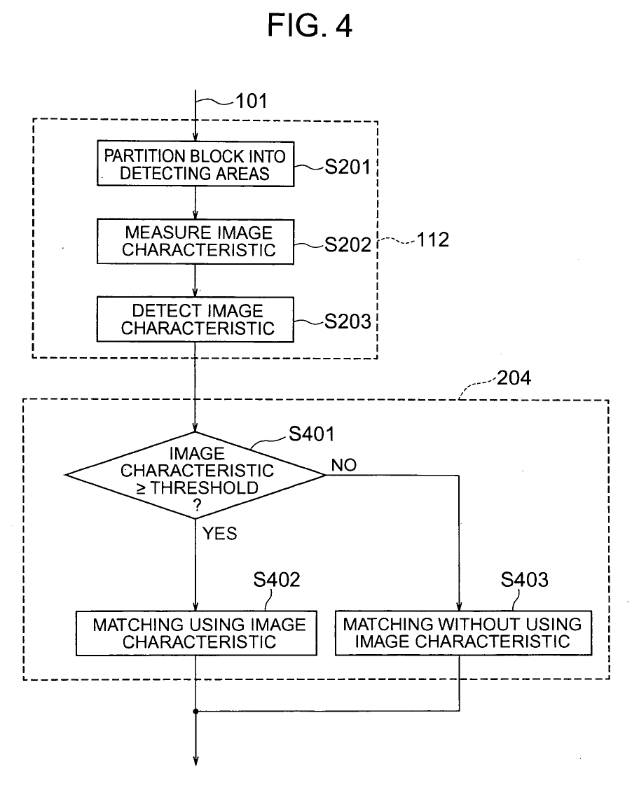

FIG. 4 shows another example of the process executed by the image characteristic detecting unit 112 and the motion detection/compensation unit, in which the above cases where the edge intensity is very low are taken into consideration. First, similarly to the above example, the image characteristic detecting unit 112 partitions each block of the input image 101 into a plurality of detecting areas (S201), measures the edge intensity (S202), and detects the image characteristic (S203). Subsequently, a threshold value regarding the edge intensity is set and when the edge intensity is greater than or equal to the threshold value (S401: YES), the block matching is executed preferentially regarding points having high edge intensity (S402). On the other hand, when the edge intensity less than the threshold value (S401: NO), matching without using the edge intensity is executed (S403) as explained below.

FIG. 3C shows an example of such a matching method not using the detected edge information. In this example, from all the pixels contained in the block 301 of the input image, matching pixels 310 to be used for the matching are selected and extracted alternately both in the horizontal direction and in the vertical direction in order to speed up of the matching process. Also in the block 302 of the reference image, pixels situated at the same positions as the matching pixels 310 are selected as matching pixels 311 to be used for the matching. Also by this method (using only 16 points as the matching pixels out of the 8×8=64 points contained in each block), high speed processing can be realized. Incidentally, while the matching pixels to be used for the matching are simply selected and extracted in this example, it is also possible to prepare reduced images of the input image and the reference image and execute the matching between such reduced images.

We carried out a simulation experiment by implementing the above methods of the coding process in an H.264/AVC software encoder. Principal conditions of the experiment are as shown in FIG. 6. In the experiment, the all-pixel comparison method of FIG. 3A, the edge-based comparison method of FIG. 3B and the simple down-sampling comparison method of FIG. 3C were compared. The block size used for the search was 8×8. The encoding mode in the P picture was also fixed at 8×8. The edge extraction was executed using the absolute value of the result of application of the Laplacian filter using 8 adjacent pixels.

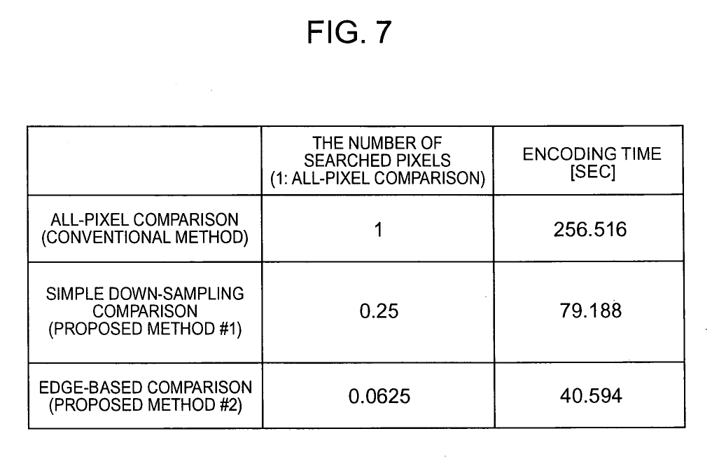

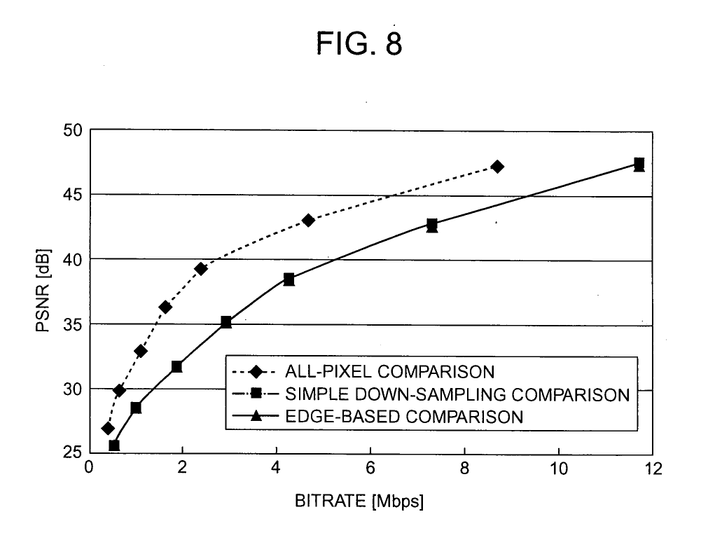

FIG. 7 shows the processing time for the encoding (in a fixed quantization precision) by each of the above methods. Thanks to the reduction of the number of pixels to be searched, the encoding time was reduced from that of the all-pixel comparison method of FIG. 3A to ⅓ or less by the simple down-sampling comparison method of FIG. 3C (proposed method #1), and further to ⅙ or less by the edge-based comparison method of FIG. 3B (proposed method #2), which indicates considerable reduction of the coding workload by the two proposed methods. FIG. 8 shows rate-distortion properties achieved by the above methods. While the PSNRs (Peak Signal-to-Noise Ratios) in the simple down-sampling comparison method and the edge-based comparison method are lower than that in the all-pixel comparison method, if we compare the edge-based comparison method and the simple down-sampling comparison method, the edge-based comparison method achieves substantially the same PSNR as the simple down-sampling comparison method even though the number of compared pixels is ¼ of that of the simple down-sampling comparison method. The result indicates that deterioration of image quality can be avoided even when the number of compared pixels is reduced to ¼, by use of information on the edge.

Incidentally, while the absolute value of the result of application of the Laplacian filter is used for the measurement of the edge intensity in the above experiment, other methods (e.g. applying a Sobel filter both in the horizontal direction and in the vertical direction and calculating the mean square value) may also be employed as long as the edge intensity can be detected successfully.

While each block is partitioned into a plurality of detecting areas and points (pixels) having high edge intensity (image characteristic value) are selected and extracted from each detecting area in the above embodiment, the partitioning into a plurality of detecting areas is not necessarily essential. For example, it is possible to simply extract an arbitrarily-specified number of points (pixels) having high edge intensity from each block and use the extracted points for the matching (e.g. detecting the edge intensity of each of the pixels contained in a block, comparing the edge intensity with a prescribed threshold value, and selecting pixels having edge intensity greater than or equal to the threshold value as the pixels to be used for the block matching). It is also possible to extract a prescribed number of pixels from the block in descending order of the edge intensity and execute the block matching using the extracted pixels.

While the edge intensity is detected as the image characteristic (image characteristic value) in the above embodiment, it is possible to detect luminance instead of the edge intensity (i.e. detecting the luminance of each of the pixels contained in each detecting area and selecting a pixel having the highest luminance in the detecting area as the aforementioned representative point). It is also possible to detect the luminance of each of the pixels contained in each detecting area and select a plurality of points (pixels) having luminance greater than or equal to a prescribed threshold value as the representative points.

In the example explained above, the number of points (pixels) used for the matching can be reduced from 64 to 4, by which the workload on the video coding device can be reduced considerably. By using such points having high edge intensity (image characteristic value representing the characteristic of the image) for the block matching process preferentially or with high priority as above, errors in motion detection (generally caused by the reduction of the workload) can be reduced or eliminated.

While the edge in the image is detected as the image characteristic in the above embodiment, luminance information may also be detected as the image characteristic as mentioned above, or an image characteristic value other than the edge intensity and luminance may also be detected.

While the edge detection is executed in each block of the input image and the block matching is executed between the input image and the reference image in the above embodiment, it is also possible to execute the edge detection in the reference image and carry out the matching regarding parts of each block of the input image that correspond to edge points detected in the reference image.

The size of the block used for the block matching process is of course not restricted to 8×8 pixels. The present invention is similarly applicable even when other block sizes are employed. Further, the shape of the block is not restricted to a square but can be a rectangle, etc. The present invention is similarly applicable to cases where blocks of other shapes (e.g. rectangle) are used.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. A video coding device for encoding video images, comprising:
a block matching processing unit which executes a block matching process for each of a plurality of blocks obtained by partitioning each of the video images; and
a characteristic detecting unit which detects a characteristic of each block, wherein:
pixels corresponding to the characteristic detected by the characteristic detecting unit are selected from each block as pixels to be used for the block matching process, and
the block matching processing unit executes the block matching process for each block using the selected pixels.

2. The video coding device according to claim 1, wherein the characteristic detecting unit detects an edge in the image as the characteristic.

3. The video coding device according to claim 1, wherein the characteristic detecting unit detects parts having luminance greater than or equal to a prescribed value as the characteristic.

4. The video coding device according to claim 1, wherein:
the block matching processing unit executes the block matching process for obtaining a motion vector based on difference between an input image and a reference image, and
the block matching process is executed using the selected pixels regarding both the input image and the reference image.

5. The video coding device according to claim 1, wherein the characteristic detecting unit partitions each block into a plurality of detecting areas and detects the characteristic in each of the detecting areas.

6. The video coding device according to claim 5, wherein:
the characteristic detecting unit selects a pixel having the highest characteristic value from each of the detecting areas of the block as a representative point of the block, and
the block matching processing unit executes the block matching process using the representative points of the block selected from the detecting areas by the characteristic detecting unit.

7. The video coding device according to claim 6, wherein:
the characteristic value is edge intensity in the image, and
the characteristic detecting unit specifies a pixel having the highest edge intensity in each detecting area as the representative point.

8. The video coding device according to claim 5, wherein:
the characteristic detecting unit selects pixels having characteristic values greater than or equal to a prescribed value from the pixels contained in the plurality of detecting areas, and
the block matching processing unit executes the block matching process using the selected pixels having characteristic values greater than or equal to the prescribed value.

9. The video coding device according to claim 8, wherein the block matching processing unit executes the block matching process using prescribed pixels selected and extracted from the block when the characteristic values of all the pixels contained in the detecting areas are less than the prescribed value.

10. A video coding device for encoding video images, comprising:
a block matching processing unit which executes a block matching process for each of a plurality of blocks obtained by partitioning each of the video images; and
a characteristic detecting unit which detects one or more pixels having characteristic values satisfying a prescribed condition in each block, wherein:
the block matching processing unit executes the block matching process exclusively using the pixels detected in each block by the characteristic detecting unit.

11. The video coding device according to claim 10, wherein:
the characteristic value is edge intensity in the image, and
the characteristic detecting unit detects pixels having the edge intensity greater than or equal to a prescribed value.

12. An image recording/reproducing device for recording and reproducing images, comprising:
a coding unit (502) which encodes an input image;
record medium (503) which record the image encoded by the coding unit; and
a reproducing unit which reproduces the input image by decoding the encoded image recorded in the record medium, wherein:
the coding unit includes a block matching processing unit which executes a block matching process for each of a plurality of blocks obtained by partitioning the image and a characteristic detecting unit which detects a characteristic of each block, and
pixels corresponding to the characteristic detected by the characteristic detecting unit are selected from each block as pixels to be used for the block matching process, and
the block matching processing unit executes the block matching process for each block using the selected pixels.

13. The image recording/reproducing device according to claim 12, further comprising a semiconductor memory as the record medium.

14. The image recording/reproducing device according to claim 12, further comprising a hard disk as the record medium.

15. The image recording/reproducing device according to claim 12, further comprising a display unit which displays the images reproduced by the reproducing unit.
